(19) United States
(12) Patent Application Publication
(10) Pub. No.: US 2015/0215724 A1
(43) Pub. Date: Jul. 30, 2015

(54) SYSTEM AND METHOD FOR MANAGING ONE OR MORE HETEROGENOUS NETWORKS

(71) Applicant: MPhasis, Bangalore (IN)

(72) Inventors: Mohan M. Hebbar, Bangalore (IN); Ganesh Karanth, Bangalore (IN); SyamKumar Sankaran, Bangalore (IN); Ravindranath Andela, Hindupur (IN)

(73) Assignee: MPHASIS, Bangalore (IN)

(21) Appl. No.: 14/602,240

(22) Filed: Jan. 21, 2015

(30) Foreign Application Priority Data
Jan. 24, 2014 (IN) 303/CHE/2014

(51) Int. Cl. H04W 4/00; H04M 3/22; H04W 8/20

(52) U.S. Cl. CPC H04W 4/001; H04W 8/20; H04M 3/2263

(57) ABSTRACT

A system and method of managing one or more heterogeneous networks is disclosed. The system is capable of adding and removing one or more heterogeneous devices in the one or more heterogeneous networks. The system includes a device management unit that is capable of adding or removing the one or more heterogeneous devices in the one or more heterogeneous networks. The one or more heterogeneous devices are operated according to preferences of a user. The preferences of the user are defined in policies that govern the operation of the one or more heterogeneous devices. Additionally, a control unit transmits control messages to the one or more heterogeneous devices according a communication protocol associated with the one or more heterogeneous devices.

### FIELD OF THE INVENTION

The invention generally relates to managing one or more heterogeneous networks. More specifically, the invention relates to adding or deleting a group of heterogeneous devices in the one or more heterogeneous networks and managing the group of heterogeneous devices in the one or more heterogeneous networks.

### BACKGROUND OF THE INVENTION

Local devices are added to a network and the local devices are managed by a device controller in the network. Conventional local devices are added to the network using either an Open Service Gateway Initiative (OSGi) framework or a proprietary framework. Additionally, service technologies for managing these local devices are implemented using either the OSGi framework or a proprietary framework.

Conventional local device controllers with heterogeneous access technologies are based on Open Service Gateway Initiative (OSGi), through the usage of Java Virtual Machine, which suffers from issues related to memory usage, start-up time and program execution. Further, a conventional local device network works with a remote server for the configuration of service and operation.

Therefore, there exists a need for an improved system and method for adding and managing local devices in a network.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the method and system disclosed herein.

FIG. 1 illustrates a simplified diagram of a system for managing one or more heterogeneous networks in accordance with various embodiments of the invention.

FIG. 2 illustrates a simplified diagram of a device management unit for managing one or more heterogeneous devices in one or more heterogeneous networks in accordance with an embodiment of the invention.

FIG. 3 illustrates a simplified diagram of a control unit configured to transmit one or more control messages to one or more heterogeneous devices in accordance with an embodiment of the invention.

FIG. 4 illustrates a simplified diagram of a policy manager unit configured to manage one or more policies associated with one or more heterogeneous devices in accordance with an embodiment of the invention.

FIG. 5 illustrates a flow diagram of a method of managing one or more heterogeneous networks in accordance with an embodiment of the invention.

FIG. 6 illustrates an exemplary scenario for managing one or more heterogeneous networks in accordance with an embodiment of the invention.

### DETAILED DESCRIPTION

As required, embodiments of the system and method are disclosed herein; however, it is to be understood that the disclosed embodiments are merely exemplary of the method, apparatus and system, which can be embodied in various forms. Therefore, specific functional details disclosed herein are not to be interpreted as limiting, but merely as a representative basis for teaching one skilled in the art to variously employ the system and method disclosed herein in virtually any appropriately detailed structure. Further, the terms and phrases used herein are not intended to be limiting but rather to provide an understandable description of the system and method disclosed herein.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Before describing in detail, embodiments that are in accordance with the method and system disclosed herein, it should be observed that the embodiments reside primarily in combinations of method steps and apparatus components and system elements related to management of one or more heterogeneous devices in one or more heterogeneous networks. Accordingly, the apparatus components, method steps and system elements have been represented where appropriate by conventional symbols in the drawings, showing only those specific details that are pertinent to understanding the embodiments of the method and system disclosed herein so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Generally speaking, pursuant to various embodiments, the invention provides a system and method for managing one or more heterogeneous networks. A heterogeneous network includes zero or more heterogeneous devices. The system includes a device management unit. The device management unit is configured to add one or more heterogeneous devices in the one or more heterogeneous networks. The one or more heterogeneous devices are added by capturing an interrupt issued from the one or more heterogeneous devices. The interrupt is captured by the device management unit. The one or more heterogeneous devices are operated based on one or more operating parameters associated with the one or more heterogeneous devices. The one or more operating parameters are defined based on one or more policies associated with the one or more heterogeneous devices. The system includes a policy manager unit that is configured to manage the one or more policies associated with the one or more heterogeneous devices in the one or more heterogeneous networks. The one or more policies are related to one or more preferences of a user. The one or more preferences of the user may be defined by the user or may be obtained from a profile of the user. The one or more heterogeneous devices are operated based on the one or more preferences of the user.

Additionally, the system includes a control unit that is configured to transmit one or more control messages to the one or more heterogeneous devices. The one or more control messages include the one or more operating parameters that are defined by the policy manager. The one or more heterogeneous devices are operated based on the reception of the one or more control messages. The one or more control messages are transmitted using one or more communication protocols associated with the one or more heterogeneous devices.

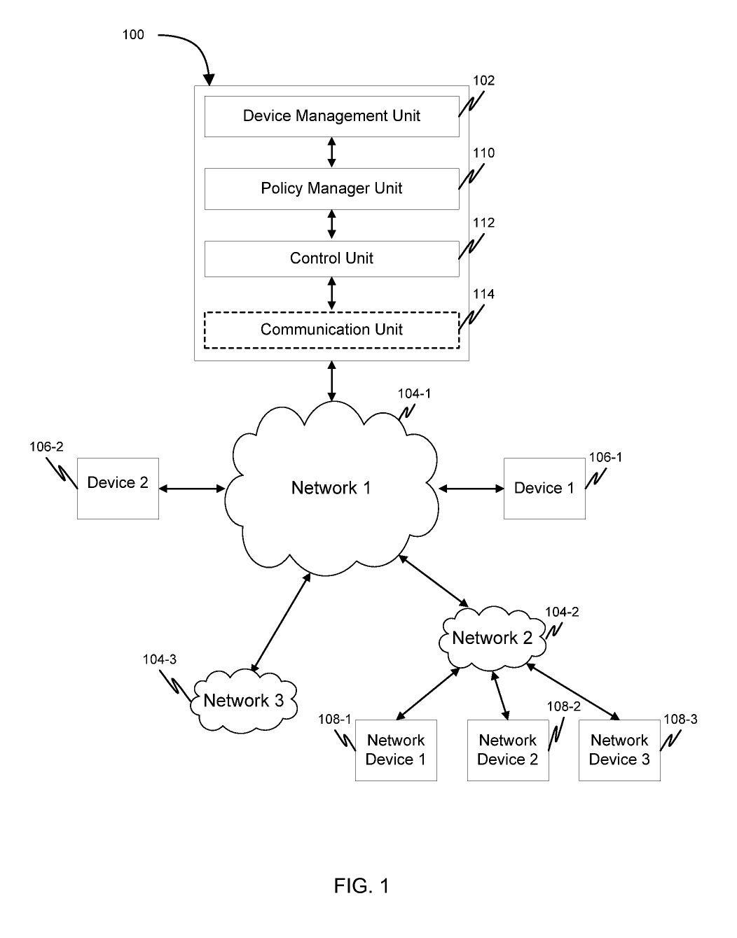

FIG. 1 illustrates a simplified diagram of a system 100 for managing one or more heterogeneous networks in accordance with various embodiments of the invention. The one or more heterogeneous networks include zero or more heterogeneous devices. The heterogeneous devices are one or more of, but not limited to, entertainment devices, utility devices, security devices and personal health monitoring devices. The entertainment devices may be one or more of, but not limited to, television, gaming devices, video players, image and video capturing devices, mobile devices, personal computers, laptops, network interfacing devices. The utility devices may be one or more of, but not limited to, lighting devices, cooling devices such as fan, air conditioners, coolers, thermostat, home appliances such as washing machines, microwave ovens, mixer grinders, refrigerators, geyser. The security devices may be one or more of, but not limited to, security cameras, controllers controlling the security cameras, sprinklers, alarm systems, smoke detectors, motion detectors. The personal health monitoring devices may be one or more of, but not limited to, blood pressure monitoring devices, heart beat monitoring devices.

As illustrated in FIG. 1, system 100 includes a device management unit 102 that is configured to manage one or more heterogeneous networks 104-n. For example, device management unit 102 is configured to manage one or more heterogeneous networks 104-n such as a heterogeneous network 104-1, a heterogeneous network 104-2 and a heterogeneous network 104-3. Further, device management unit 102 is configured to add one or more heterogeneous devices 106-n to the one or more heterogeneous networks 104-n. For example, a heterogeneous device 106-1 and a heterogeneous device 106-2 are added to heterogeneous network 104-1 using device management unit 102. In an embodiment, device management unit 102 is configured to manage heterogeneous network 104-2 and heterogeneous network 104-3. Device management unit 102 connects to heterogeneous network 104-2 and heterogeneous network 104-3 via respective gateways of heterogeneous network 104-2 and heterogeneous network 104-3. Similarly, device management unit 102 is configured to manage a heterogeneous device 108-1, a heterogeneous device 108-2 and a heterogeneous device 108-3 of heterogeneous network 104-2.

One or more heterogeneous devices 106-n are added to one or more heterogeneous networks 104-n by capturing interrupts issued due to inclusion of one or more heterogeneous devices 106-n. The interrupts may be issued directly or indirectly by one or more heterogeneous devices 106-n. The interrupts are captured by device management unit 102. Alternately, device management unit 102 is configured to capture interrupts issued by heterogeneous network 104-2 and heterogeneous network 104-3. The interrupts captured by device management unit 102 is used to manage heterogeneous network 104-2 and heterogeneous network 104-3 and add heterogeneous network 104-2 and heterogeneous network 104-3 to heterogeneous network 104-1.

Additionally, device management unit 102 is configured to extract information from one or more heterogeneous devices 106-n. The information relates to one or more of, classification information of one or more heterogeneous devices 106-n, one or more operating parameters of one or more heterogeneous devices 106-n and one or more communication protocols associated with one or more heterogeneous devices 106-n. The information obtained from one or more heterogeneous devices 106-n is segmented according to the classification information, the one or more operating parameters and the one or more communication protocols. For example, if heterogeneous device 106-1 is a mobile phone, then information regarding the mobile phone is extracted. The classification information includes type of the mobile phone. The operating parameters of the mobile phone include capabilities and technical specification of the mobile phone. Further, the communication protocol of the mobile phone includes a list of communication mechanisms that the mobile phone is capable of communicating with. A list of the information extracted from one or more heterogeneous devices 106-n is maintained by device management unit 102. The list includes one or more of, but not limited to, classification information of one or more heterogeneous devices 106-n, one or more operating parameters of one or more heterogeneous devices 106-n, one or more communication protocols associated with one or more heterogeneous devices 106-n and current operating status of one or more heterogeneous devices 106-n. The current operating status indicates if one or more heterogeneous device 106-n is one or more of, but not limited to, active, inactive, added or deleted in heterogeneous network 104-1.

In accordance with various embodiments of the invention, device management unit 102 is capable of removing one or more heterogeneous devices 106-n from one or more heterogeneous networks 104-n. The removal of one or more heterogeneous devices 106-n is performed based on pre-defined criteria. The pre-defined criteria may be defined by a user. Alternately, the pre-defined criteria may be related to operational data of one or more heterogeneous devices 106-n. For example, if a heterogeneous device 106-1 is not in operation, then device management unit 102 removes heterogeneous device 106-1 from heterogeneous network 104-1.

As further illustrated in FIG. 1, system 100 includes a policy manager unit 110 that is configured to manage one or more policies associated with one or more heterogeneous devices 106-n. The one or more policies define the one or more operating parameters associated with one or more heterogeneous devices 106-n. The one or more policies are associated with one or more preferences of the user. The user may define the one or more preferences according to daily habits of the user. For example, if the user reaches home from office at 8 pm, then a policy may be defined by the user to switch on lighting equipment of a house of the user at 8 pm. In this case, switching on the lighting equipment is the operating parameter of the lighting equipment.

The one or more operating parameters associated with one or more heterogeneous devices 106-n are set using a control unit 112. Control unit 112 transmits one or more control messages to one or more heterogeneous devices 106-n. The one or more control messages are configured to set the one or more operating parameters of one or more heterogeneous devices 106-n. The one or more operating parameters are set upon receiving a policy associated with one or more heterogeneous devices 106-n. Control unit 112 receives an acknowledgment message from one or more heterogeneous devices 106-n upon transmitting the one or more control messages.

Further, system 100 includes a communication unit 114 that is configured to transmit the one or more control messages using control unit 112 according to one or more communication protocols associated with one or more heterogeneous devices 106-n. The one or more communication protocol includes one or more of, but not limited to, wired protocols like Serial, Ethernet, USB, X10, Power line Communication and wireless protocols like Bluetooth, Wi-Fi, ZigBee, Z-Wave, Infrared, Ultra-Wideband (UWB), Short-Wave Radio Communication, and Near Field Communication (NFC). For example, if heterogeneous device 106-1 is capable of communicating using Bluetooth communication protocol, then communication unit 114 transmits the one or more control messages using Bluetooth communication protocol. Communication unit 114 includes a service handler unit that is configured to manage the one or more communication protocols. The service handler unit is responsible for translating each communication message to a particular type of communication protocol. For example, if a control message is transmitted for a heterogeneous device 106-1 that communicates using Bluetooth communication protocol, then the control message is translated by the service handler unit so that the control message is transmitted using Bluetooth communication protocol.

In accordance with an embodiment of the invention, system 100 is further configured to be a standalone system in absence of any heterogeneous networks 104-n. In an exemplary embodiment, system 100 acting as a standalone system may function as one or more of, but not limited to, a multimedia player, a gaming console, a computing device, a temperature monitor, a timer, a media capture and playback device and an FM radio.

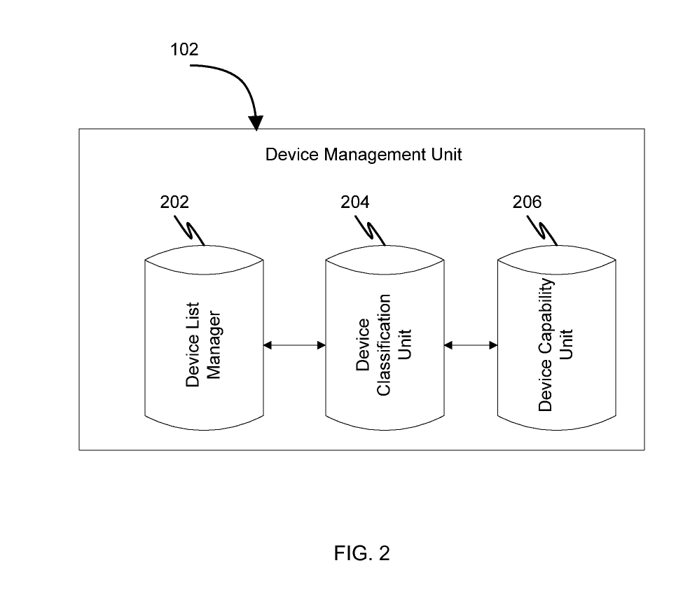

FIG. 2 illustrates a simplified diagram of a device management unit 102 for managing one or more heterogeneous devices 106-n in one or more heterogeneous networks 104-n in accordance with an embodiment of the invention. As illustrated in FIG. 2, device management unit 102 includes a device list manager 202 that is configured to store a list of one or more heterogeneous devices 106-n that are added to a heterogeneous network. A list of one or more heterogeneous devices 106-n that are added to the heterogeneous network is stored in a local database. The list includes current operating status of one or more heterogeneous devices 106-n present in the heterogeneous network.

Additionally, device management unit 102 is capable of extracting information from each of one or more heterogeneous devices, 106-n that are added to a heterogeneous network. The information includes classification information, one or more operating parameters and one or more communication protocols associated with each heterogeneous device. For example, if heterogeneous device 106-1 is a mobile phone, then information regarding the mobile phone is extracted. The classification information includes type of the mobile phone. The operating parameters of the mobile phone include capabilities and technical specification of the mobile phone. Further, the communication protocol of the mobile phone includes a list of communication mechanisms that the mobile phone is capable of communicating with.

As shown in FIG. 2, device list manager 202 includes a device classification unit 204 and device capability unit 206. Device classification unit 204 is configured to store the classification information extracted from one or more heterogeneous devices 106-n. The classification information enables device classification unit 204 to classify one or more heterogeneous devices 106-n according to a type of device. A unique identification number is assigned to each heterogeneous device that is added to the heterogeneous network. The unique identification number is added to the local database and added against each heterogeneous device in the list maintained by device list manager 202.

Further, device capability unit 206 is capable of extracting one or more operating parameters and one or more communication protocols associated with each heterogeneous device. The one or more operating parameters and one or more communication protocols are stored by device capability list unit 206. The one or more operating parameters and the one or more communication protocols are matched to each unique identification number of each heterogeneous device.

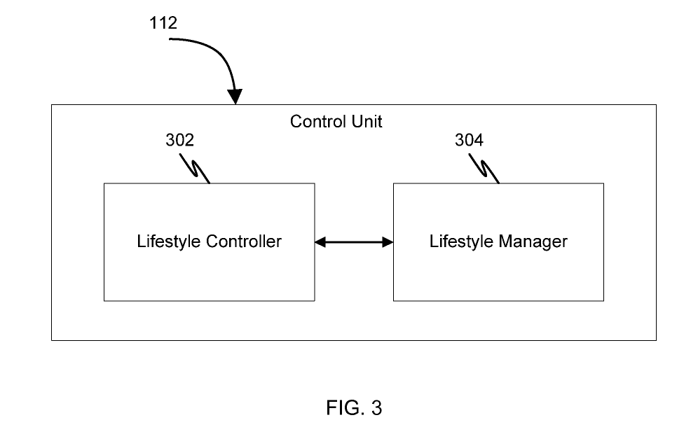

Moving on, FIG. 3 illustrates a simplified diagram of a control unit 112 configured to transmit one or more control messages to one or more heterogeneous devices 106-n in accordance with an embodiment of the invention. As shown in FIG. 3, control unit 112 includes a lifestyle controller 302 and a lifestyle manager 304. Lifestyle controller 302 is operatively connected to control unit 112 to configure one or more heterogeneous devices 106-n. The configuration of one or more heterogeneous devices 106-n is based on one or more preferences of a user. The one or more preferences of the user are provided using lifestyle controller 302. Lifestyle controller 302 includes one or more sub-controllers for controlling each type of heterogeneous device. For example, a security sub-controller is configured to control security devices and a media sub-controller is configured to control entertainment devices. Additionally, control unit 112 includes lifestyle manager 304 that is configured to manage the one or more sub-controllers associated with each type of heterogeneous device. The managing of the one or more sub-controllers includes sending and receiving the one or more operating parameters from the sub-controller to each type of heterogeneous device.

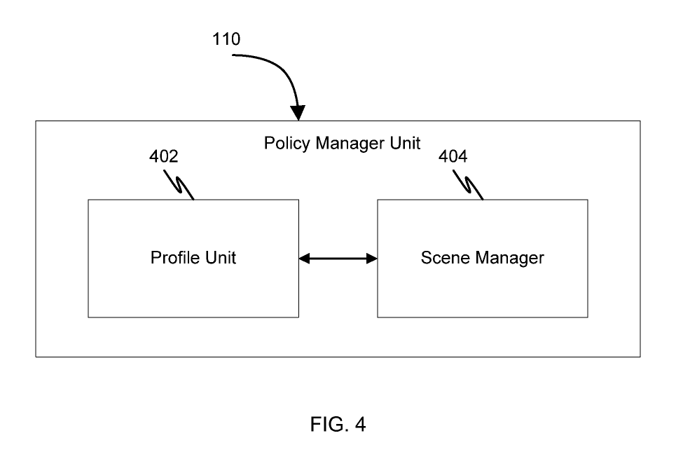

FIG. 4 illustrates a simplified diagram of a policy manager unit 110 configured to manage one or more policies associated with one or more heterogeneous devices 106-n in accordance with an embodiment of the invention. As illustrated in FIG. 4, policy manager unit 110 includes a profile unit 402 and a scene manager 404. Profile unit 402 is configured to store profiles of one or more users. The profile includes one or more of, but not limited to, personal details of the one or more users such as but not limited to, name, address, date of birth, occupational details, marital status, etc. The personal details enables profile unit 402 to determine one or more preferences of a user. Alternately, the user may define one or more preferences. The one or more preferences are related to the one or more operating parameters of the one or more heterogeneous devices. For example, if a user leaves for office at 9 am, then user may prefer to switch off all lighting equipment at a home of the user after 9 am. The profile information of the user is provided to scene manager 404 that matches preferences of the user with one or more heterogeneous devices 106-n. Scene manager 404 defines one or more operating parameters of one or more heterogeneous devices 106-n based on one or more parameters of the user.

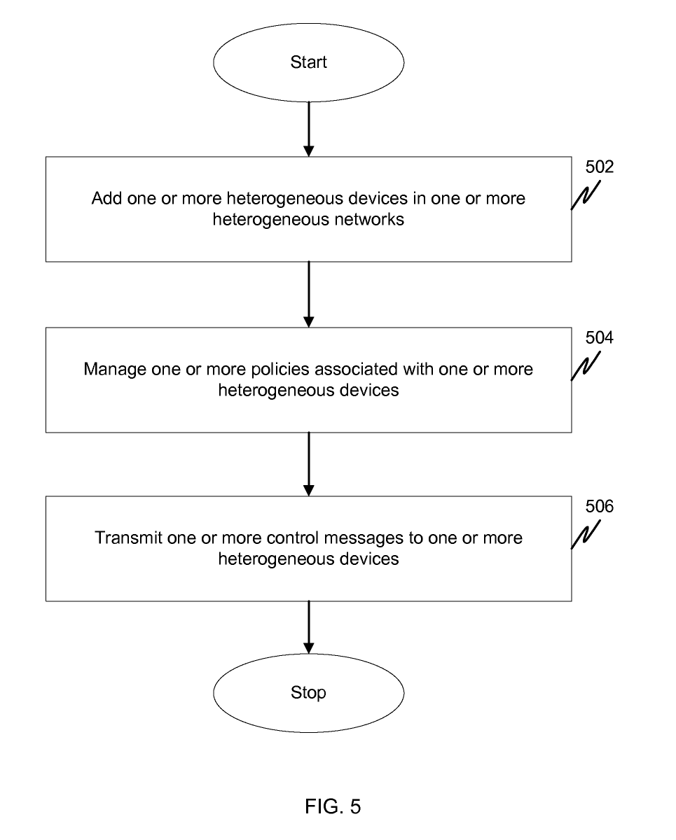

FIG. 5 illustrates a flow diagram of a method of managing one or more heterogeneous networks in accordance with an embodiment of the invention. The one or more heterogeneous network includes zero or more heterogeneous devices.

At step 502, one or more heterogeneous devices are added to a heterogeneous network of the one or more heterogeneous networks. An interrupt issued due to inclusion of the one or more heterogeneous devices is captured and the one or more heterogeneous devices are added to the heterogeneous network. The heterogeneous devices are one or more of, but not limited to, entertainment devices, utility devices, security devices and personal health monitoring devices. The entertainment devices may be one or more of, but not limited to, television, gaming devices, video players, image and video capturing devices, mobile devices, personal computers, laptops, network interfacing devices. The utility devices may be one or more of, but not limited to, lighting devices, cooling devices such as fan, air conditioners, coolers, home appliances such as washing machines, microwave ovens, mixer grinders, refrigerators, etc. The security devices may be one or more of, but not limited to, security cameras, controllers controlling the security cameras, sprinklers, alarm systems, smoke detectors, etc. The personal health monitoring devices may be one or more of, but not limited to, blood pressure monitoring devices, heart beat monitoring devices, etc.

The addition of the one or more heterogeneous devices includes extraction of information from the one or more heterogeneous devices. The information relates to one or more of, classification information of the one or more heterogeneous devices, one or more operating parameters of the one or more heterogeneous devices and one or more communication protocols associated with the one or more heterogeneous devices. The information obtained from the one or more heterogeneous devices is segmented according to the classification information, the one or more operating parameters and the one or more communication protocols. For example, if a heterogeneous device is a mobile phone, then information regarding the mobile phone is extracted. The information includes classification of the mobile phone, capabilities and operating parameters of the mobile phone and communication protocols supported by the mobile device. A list of the information extracted from the one or more heterogeneous devices is maintained.

Moving on to step 504, one or more policies governing operation of the one or more heterogeneous devices is managed. The one or more policies define the one or more operating parameters associated with the one or more heterogeneous devices. The one or more policies are associated with one or more preferences of a user. The user may define the one or more preferences according to daily habits of a user. For example, if the user reaches home from office at 8 pm, then a policy may be defined by user to switch on lighting equipment of a house of the user at 8 pm in the evening. In this case, switching on the lighting equipment is the operating parameter of the lighting equipment.

At step 506, the one or more control messages are transmitted to the one or more heterogeneous devices. The one or more control messages are configured to set the one or more operating parameters of the one or more heterogeneous devices. The one or more operating parameters are set upon receiving a policy associated with the one or more heterogeneous devices. The one or more control messages are transmitted according to one or more communication protocols associated with one or more heterogeneous devices. The one or more communication protocol includes one or more of, but not limited to, wired protocols like Serial, Ethernet, USB, X10, Power line Communication and wireless protocols like Bluetooth, Wi-Fi, ZigBee, Z-Wave, Infrared, Ultra-Wideband (UWB), Short-Wave Radio Communication, and Near Field Communication (NFC).

Additionally, one or more operating status messages of the one or more heterogeneous devices are received from the one or more heterogeneous devices using the one or more communication protocols. The one or more operating status messages indicates if the one or more heterogeneous devices are one or more of, but not limited to, active, inactive, added or deleted in the one or more heterogeneous network. For example, if a thermostat present in a heterogeneous network is unable to control temperature of a room, then an operating status message indicating inability of the thermostat is received.

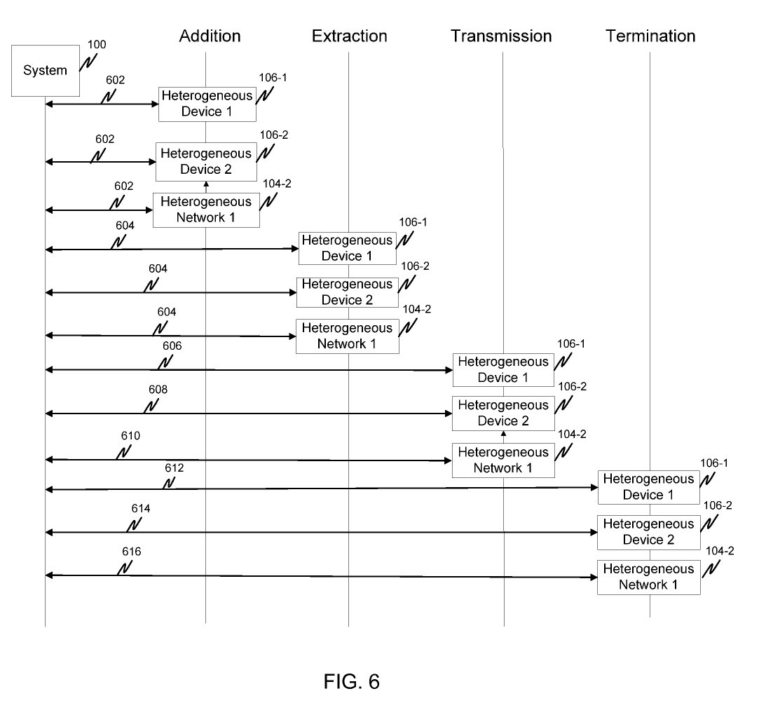

FIG. 6 illustrates an exemplary scenario for managing a heterogeneous device 106-1, a heterogeneous device 106-2 and a heterogeneous network 104-2 in accordance with an embodiment of the invention. As illustrated in FIG. 6, at 602, a heterogeneous device 106-1, a heterogeneous device 106-2 and a heterogeneous network 104-2 are added by system 100. The addition is performed by capturing an interrupt issued due to inclusion of heterogeneous device 106-1, heterogeneous device 106-2 and heterogeneous network 104-2 by system 100.

Thereafter, at 604, system 100 extracts information from heterogeneous device 106-1, heterogeneous device 106-2 and heterogeneous network 104-2. The information relates to one or more of, classification information of heterogeneous device 106-1, heterogeneous device 106-2 and heterogeneous network 104-2, one or more operating parameters of heterogeneous device 106-1, heterogeneous device 106-2 and heterogeneous network 104-2 and one or more communication protocols associated with heterogeneous device 106-1, heterogeneous device 106-2 and heterogeneous network 104-2. The information obtained from one or more heterogeneous devices 106-n is segmented according to the classification information, the one or more operating parameters and the one or more communication protocols. For example, if heterogeneous device 106-1 is a mobile phone, then information regarding the mobile phone is extracted. The classification information includes type of the mobile phone. The operating parameters of the mobile phone include capabilities and technical specification of the mobile phone. Further, the communication protocol of the mobile phone includes a list of communication mechanisms that the mobile phone is capable of communicating with.

Moving on at 606, system 100 transmits one or more control messages to heterogeneous device 106-1. The one or more control messages are configured to set the one or more operating parameters of heterogeneous device 106-1. The one or more operating parameters are set upon receiving a policy associated with heterogeneous device 106-1. An acknowledgement message, for acknowledging receipt of one or more control messages, is received by system 100. The acknowledgment message is received from heterogeneous device 106-1. Similarly, at 608, system 100 transmits one or more control messages to heterogeneous device 106-2. At 610, system 100 transmits one or more control messages to heterogeneous network 104-2.

At 612, system 100 terminates management of heterogeneous device 106-1. System 100 issues a command using communication channel 614 to remove heterogeneous device 106-1. The removal of heterogeneous device 106-1 is performed based on pre-defined criteria. The pre-defined criteria may be defined by a user. Alternately, the pre-defined criteria may be related to operational data of heterogeneous device 106-1. For example, if a heterogeneous device 106-1 is not in operation, then system 100 removes heterogeneous device 106-1. Similarly, at 614, system 100 issues a command to remove heterogeneous device 106-2. At 616, system 100 issues a command to remove heterogeneous network 104-2.

Various embodiments of the invention provide a system and method for managing one or more heterogeneous devices in one or more heterogeneous networks. The system and method provides a heterogeneous framework to seamlessly add or remove one or more heterogeneous devices in the network. The method and system is not restricted to either an OSGi framework or any proprietary framework. The system is also capable of performing as a standalone system and performing varied functions.

Those skilled in the art will realize that the above-recognized advantages and other advantages described herein are merely exemplary and are not meant to be a complete rendering of all of the advantages of the various embodiments of the method and system disclosed herein.

In the foregoing specification, specific embodiments of the invention have been described. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A system for managing at least one heterogeneous network, wherein a heterogeneous network of the at least one heterogeneous network comprising zero or more heterogeneous devices, the system comprising:
a device management unit configured to add at least one heterogeneous device in a heterogeneous network of the at least one heterogeneous network, wherein an interrupt issued by a heterogeneous device is captured by the device management unit to add the heterogeneous device in a heterogeneous network;
a policy manager unit configured to manage at least one policy associated with the at least one heterogeneous device, wherein a policy associated with a heterogeneous device defines at least one operating parameter of the heterogeneous device based on at least one preference of a user; and
a control unit configured to transmit at least one control message to the at least one heterogeneous device, wherein the at least one control message sets the at least one operating parameter associated with a heterogeneous device in response to receiving a policy from the policy manager unit.

2. The system as claimed in claim 1, wherein the device management unit is further configured to extract a set of information from the at least one heterogeneous device, wherein the set of information comprises at least one of at least one device type of a heterogeneous device, at least one operating parameter of the heterogeneous device and at least one communication protocol associated with the heterogeneous device.

3. The system as claimed in claim 2 further comprising a communication unit configured to transmit at least one control message using one of at least one communication protocol associated with a heterogeneous device.

4. The system as claimed in claim 2, wherein the device management unit is configured to maintain a list of the at least one heterogeneous devices that are present in the at least one heterogeneous networks, wherein the list comprises at least one device type of a heterogeneous device, at least one operating parameter of a heterogeneous device, at least one communication protocol associated with a heterogeneous device and current operating status of a heterogeneous device.

5. The system as claimed in claim 2, wherein a communication protocol comprises at least one of wired protocols like Serial, Ethernet, USB, X10, Power line Communication or wireless protocols like Bluetooth, Wi-Fi, ZigBee, Z-Wave, Infrared, Ultra-Wideband (UWB), Short-Wave Radio Communication, and Near Field Communication (NFC).

6. The system as claimed in claim 1, wherein the device management unit is further configured to remove at least one heterogeneous device from the at least one heterogeneous network based on a predefined criteria.

7. The system as claimed in claim 1 further configured to function as, at least one of, a multi-media player, a gaming console, a computing device, a temperature monitor, a timer, a media capture and playback device and a radio.

8. A method of managing at least one heterogeneous network, wherein a heterogeneous network of the at least one heterogeneous network comprising zero or more heterogeneous devices, the method comprising:
adding at least one heterogeneous device in a heterogeneous network of the at least one heterogeneous network, wherein an interrupt issued by a heterogeneous device is captured in order to add the device in a heterogeneous network;
managing at least one policy associated with the at least one heterogeneous device wherein a policy associated with a heterogeneous device defines at least one operating parameter of the heterogeneous device based on at least one preference of a user; and
transmitting at least one control message to the at least one heterogeneous device, wherein the at least one control message sets at least one operating parameter associated with a heterogeneous device in response to receiving a policy associated with the heterogeneous device.

9. The method as claimed in claim 8, wherein adding at least one heterogeneous device further comprising:
extracting a set of information from each heterogeneous device, wherein the set of information comprises at least one of at least one device type (category/classification) of a heterogeneous device, at least one operating parameter of the heterogeneous device and at least one communication protocol associated with the heterogeneous device.

10. The method as claimed in claim 9, wherein at least one communication protocol is used to transmit at least one control message to at least one heterogeneous device.

11. The method as claimed in claim 9 further comprising:
maintaining a list of the at least one heterogeneous devices that are present in the at least one heterogeneous networks, wherein the list comprises at least one device type of a heterogeneous device, at least one operating parameter of a heterogeneous device, at least one communication protocol associated with a heterogeneous device and current operating status of a heterogeneous device.

12. The method as claimed in claim 8 further comprising removal of at least one heterogeneous device at least one heterogeneous device from the at least one heterogeneous network based on a predefined criteria.
